(19) United States
(12) Patent Application Publication
(10) Pub. No.: US 2013/0038087 A1
(43) Pub. Date: Feb. 14, 2013

(54) VEHICLE PANEL AND ATTACHMENT SYSTEM

(71) Applicant: Roy Linwood Woodard, JR., Statesboro, GA (US)

(72) Inventor: Roy Linwood Woodard, JR., Statesboro, GA (US)

(73) Assignee: CLUB CAR, INC., Evans, GA (US)

(21) Appl. No.: 13/208,592

(22) Filed: Aug. 12, 2011

(51) Int. Cl. B62D 33/02; F16B 2/12; B60R 11/00

(52) U.S. Cl. 296/182.1; 296/183.1; 211/94.01

(57) ABSTRACT

A cargo bed of a utility vehicle includes an extruded wall panel with an integrally-formed track and an attachment assembly that can be positioned on the track and secured without the use of tools. The attachment assembly includes a first piece that is inserted into the track and a second piece that abuts an outer surface of the track. The attachment assembly also includes a clamping mechanism that draws the first and second pieces together to clamp a portion of the track between them. The attachment assembly may include a spring that biases the first and second pieces together, such that insertion of the first piece into the track includes a push-and-twist action to overcome the spring bias, properly insert the first piece through a slot, and locate the first piece within the track.

### BACKGROUND

The present invention relates to a side panel arrangement for the cargo bed of a utility vehicle, and an attachment system for use with the panel arrangement.

### SUMMARY

In one embodiment, the invention provides a cargo bed for a utility vehicle, the cargo bed comprising: a floor arranged generally horizontally on the vehicle; a plurality of side panels mounted to the floor and extending vertically, the floor and the side panels defining between them a cargo holding space; a track formed integrally with at least one of the side panels; and an attachment adapted to be inserted into the track, moved along the track into a desired position, and clamped with respect to the track to resist movement of the attachment with respect to the side panel.

In some embodiments, the track defines a channel and includes lips that define a slot for access to the channel; wherein the attachment includes a first piece, a second piece, and a clamping mechanism interconnecting the first piece and second piece; wherein the first piece is sized and shaped to be inserted into the channel through the slot, and once within the channel, turned such that the first piece bears against the lips from within the channel; wherein the second piece is sized and shaped to extend across the slot and bear against the track outside of the channel; wherein the clamping mechanism is actuable in a first direction to draw the first piece toward the second piece to clamp a portion of the track between the first and second pieces and rigidly affix the attachment with respect to the side panel; and wherein the clamping mechanism is actuable in a second direction to move the first piece away from the second piece to release a clamping force between the first and second piece on the track, such that the attachment may be slid along the track to a desired location. In some embodiments, the attachment further includes a linear spring biasing the first and second pieces toward each other; and the first piece is inserted into the channel through the slot by applying a manual force to overcome the bias of the linear spring to separate the first piece from the second piece a sufficient distance to position the first piece within the channel. In some embodiments, the attachment includes a first piece, a second piece, and a clamping mechanism interconnecting the first piece and second piece; wherein the clamping mechanism is actuable in a first direction to draw the first portion toward the second portion to clamp a portion of the integrally-formed track between the first portion and second portion. In some embodiments, each side panel defines oppositely-facing first and second vertical surfaces, the first vertical surface of each side panel facing into the cargo space and the second vertical surface of each side panel facing away from the cargo space; wherein the integrally-formed track is formed in one of the first vertical surface and second vertical surface. In some embodiments, the integrally-formed track includes a base wall, first and second sidewalls extending from the base wall, a first front wall extending from the first sidewall, a second front wall extending from the second sidewall, a first lip extending from the first front wall, a second lip extending from the second front wall, and a slot between the first and second lips; wherein a portion of the clamping mechanism extends through the slot; wherein actuation of the clamping mechanism causes the first portion of the attachment to bear against one side of the first and second lips and causes the second portion of the attachment to bear against an opposite side of the first and second lips. In some embodiments, the cargo bed further comprising resilient strips adapted for insertion into the track to create a flush surface on the side panel. In some embodiments, wherein the attachment is releasable by actuating the clamping mechanism in a second direction opposite the first direction; wherein the attachment is slidable within the track to a new position; and wherein the attachment is secured in the new position by actuating the clamping mechanism in the first direction. In some embodiments, at least one of the side panels is extruded to form alternating tracks opening inwardly and outwardly with respect to the cargo space, such that attachments can be mounted on opposite sides of the side panels for attachment of objects within and without the cargo space.

In another embodiment, the invention provides an attachment for use in a cargo bed having a track that includes lips and a slot between the lips, the slot having a slot width, the attachment comprising: a first piece; a second piece; and a clamping mechanism interconnecting the first piece and second piece; wherein the first piece is sized and shaped to be inserted into the slot, and once within the track, turned such that the first piece bears against the lips from within the track; wherein the second piece is sized and shaped to extend across the slot and bear against the track outside of the track; wherein the clamping mechanism is actuable in a first direction to draw the first piece toward the second piece to clamp a portion of the track between the first and second pieces and rigidly fix the attachment with respect to the track; and wherein the clamping mechanism is actuable in a second direction to move the first piece away from the second piece to release a clamping force between the first and second piece on the track, such that the attachment may be slid along the track to a desired location.

In some embodiments, the clamping mechanism includes a user graspable knob and a threaded shaft affixed to the knob for rotation with the knob; wherein the threaded shaft extends through a hole in the first piece and threads into the second piece; wherein the clamping mechanism is actuable in the first direction without the use of tools by rotating the knob and threaded shaft to draw the first piece toward the second piece; and wherein the clamping mechanism is actuable in the second direction without the use of tools by rotating the knob and threaded shaft to move the first piece away from the second piece. In some embodiments, the first piece comprises a t-nut having a hub and shoulders on opposite sides of the hub; wherein the t-nut has a width slightly less than the slot width and a length larger than the slot width; wherein the shoulders engage the lips from within the track with the hub being received within the slot. In some embodiments, the clamping mechanism is interconnected with the first piece and extends through the second piece; the attachment further comprising a linear spring between the second piece and a portion of the clamping mechanism; wherein the linear spring biases the clamping mechanism in a clamping direction to move the first piece toward the second piece. In some embodiments, the first piece includes a width that is slightly smaller than the slot width and a length that is larger than the slot width; wherein the clamping mechanism is manually actuated to deflect the linear spring and move the first piece away from the second piece in an unclamping direction with the first piece parallel to the slot, such that the first piece passes through the slot and into the track; and wherein the clamping mechanism is rotatable to rotate the first piece within the track to position the first piece perpendicular to the slot such that the first piece extends across the slot.

In another embodiment, the invention provides a method for configuring a cargo bed of a utility vehicle, the method comprising: extruding a plurality of side panels for the cargo bed, wherein at least one of the side panels includes an integrally-formed track that is formed within the side panel while extruding the side panel, the track including a pair of lips that at least partially define a c-shaped channel, a slot having a slot width being defined between the lips; providing a cargo bed floor arranged generally horizontally on the vehicle; mounting the plurality of side panels to the floor with the side panels extending vertically; providing an attachment that includes a first piece, a second piece, and a clamping mechanism interconnecting the first piece and second piece; inserting the first piece into the c-shaped channel through the slot; twisting the first piece within the c-shaped channel such that the first piece extends across the slot against the lips within the c-shaped channel; moved the attachment along the track into a desired position; and actuating the clamping mechanism to draw the first piece toward the second piece to clamp the lips of the track between the first and second pieces to resist movement of the attachment with respect to the side panel.

In some embodiments, the step of extruding a plurality of panels includes integrally-forming in the panel at least one track that opens inward to a cargo space within the cargo bed, at least one track that opens outward away from the cargo space, and at least one track that opens upward away from the cargo bed floor. In some embodiments, providing an attachment includes providing a user graspable knob and a threaded shaft affixed to the knob for rotation with the knob, extending the threaded shaft through a hole in the first piece and threading the threaded shaft into the second piece; wherein actuating the clamping mechanism in the first direction includes grasping the user graspable knob and rotating the knob without the use of tools to draw the first piece toward the second piece. In some embodiments, providing the attachment includes providing a t-nut as the first piece, the t-nut having a hub and shoulders on opposite sides of the hub; wherein inserting the first piece in the c-shaped channel through the slot includes aligning the t-nut parallel to the slot; wherein twisting the first piece includes rotating the t-nut within the c-shaped channel to be perpendicular to the slot; and wherein actuating the clamping mechanism includes engaging the lips from within the c-shaped channel with shoulders. In some embodiments, providing an attachment includes providing a linear spring between the second piece and a portion of the clamping mechanism; wherein the linear spring biases the clamping mechanism in a clamping direction to move the first piece toward the second piece. In some embodiments, providing an actuator includes making the width of the first piece slightly smaller than the slot width and making a length of the first piece larger than the slot width; wherein inserting the first piece into the c-shaped channel through the slot includes pushing on the clamping mechanism to deflect the linear spring and move the first piece away from the second piece in an unclamping direction with the first piece parallel to the slot; and wherein actuating the clamping mechanism includes manually rotating the clamping mechanism without the use of tools to rotate the first piece within the c-shaped channel to position the first piece perpendicular to the slot such that the first piece extends across the slot.

Other aspects of the invention will become apparent by consideration of the detailed description and accompanying drawings.

### BRIEF DESCRIPTION OF THE DRAWINGS

FIG. 1 is a perspective view of a utility vehicle embodying the present invention.

FIG. 2 is a cross section view of a side panel of the cargo bed of the vehicle, taken along line 2-2 in FIG. 1.

FIG. 3 is an exploded view of an attachment assembly for mounting to the side panel.

FIG. 4 is an exploded view of the attachment assembly from a different perspective than that of FIG. 3.

FIG. 5 is a perspective view of a first step in mounting the attachment assembly to the side panel.

FIG. 6 is a perspective view of a second step in mounting the attachment assembly to the side panel.

FIG. 7 is a perspective view of a third step in mounting the attachment assembly to the side panel.

FIG. 8 is a perspective view of a fourth step in mounting the attachment assembly to the side panel.

FIG. 9 is a perspective view of a fifth step in mounting the attachment assembly to the side panel.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

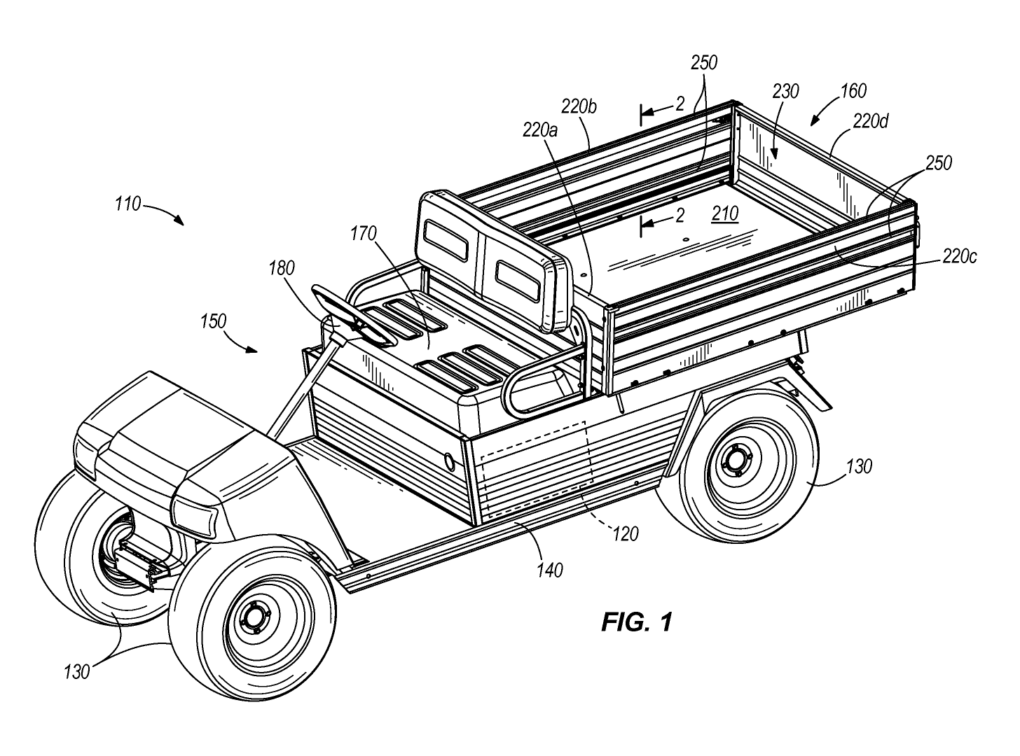

FIG. 1 illustrates a utility vehicle 110 embodying the present invention. As used in this specification, the term “utility vehicle” includes off-road vehicles having a cargo bed and low speed on-road vehicles having a cargo bed. The utility vehicle 110 includes a prime mover 120, four wheels 130, a frame 140, an operator zone 150, and a cargo bed 160. The prime mover 120 may be a gasoline-powered internal combustion engine, a battery-powered electric motor, or a hybrid engine powered by gasoline and electricity. The prime mover 120 may include an array of hydraulic pumps and motors driven by the engine or motor. At least two of the four wheels 130 are driven by the prime mover 120 to propel the vehicle 110; all four wheels 130 may be driven if the vehicle 110 is configured as a four-wheel-drive vehicle. Two of the wheels 130 (the front wheels in the illustrated embodiment) are used to steer the vehicle 110 while it is moving. The frame 140 of the vehicle 110 is supported by the wheels 130. The operator zone 150 is supported by the vehicle frame 140 and includes all parts of the vehicle 110 accessible by the operator of the vehicle during operation. The operator zone 150 includes a seat 170 for the operator, and all of the controls (e.g., pedals and a steering wheel 180 in the illustrated embodiment) used by the operator to operate the vehicle 110.

The cargo bed 160 includes a cargo floor 210, a front panel 220a, a right panel 220b, a left panel 220c, and a rear panel 220d. The front, right, left, and rear panels 220a, 220b, 220c, 220d may be referred to generically as the “side panels 220” of the cargo bed 160. The rear panel 220d may be hinged and configured as a tailgate that can be lowered for loading and unloading cargo into the cargo bed 160. A cargo space 230 is defined between the side panels 220 and above the cargo floor 210. The cargo floor 210 may be pivotally coupled to the rear of the vehicle 110, and pivotable to facilitate dumping cargo from the rear end of the cargo bed 160. In the illustrated embodiment, the right and left panels 220b, 220c include integral tracks 250 (as will be discussed below) and the front and rear panels 220a, 220d are conventional, flat panels. In other embodiments, integral tracks 250 can be formed in the front and side panels 220a, 220d as well.

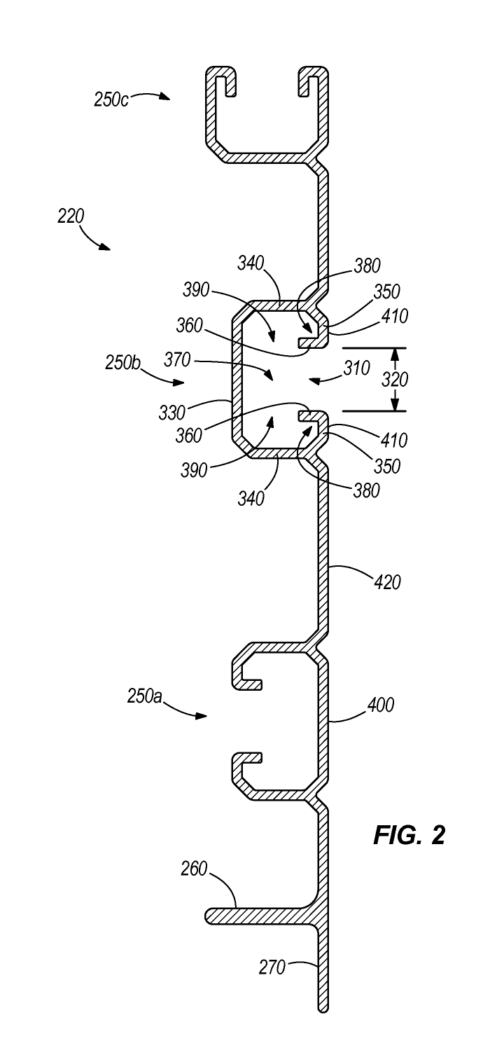

FIG. 2 illustrates a cross-section of the right panel 220b, which is a single-piece aluminum extrusion in the illustrated embodiment. Although the right panel 220b is illustrated, the following description applies to each of the side panels 220, depending on the chosen configuration for the cargo bed 160 of a particular vehicle 110.

The panel 220 includes a panel flange 260 that sits against the cargo floor 210 and a panel mounting tab 270 which extends into a slot in the cargo floor 210. The panel 220 is mounted to the cargo floor 210 by bolting the panel mounting tab 270 to a frame of the cargo floor 210 or cargo bed 160, and fastening the panel flange 260 to the cargo floor 210 with fasteners. The panel 220 includes three integrally-formed tracks 250: an inwardly-opening track 250a, an outwardly-opening track 250b, and an upwardly-opening track 250c. Because the tracks 250a, 250b, 250c are substantially identical, they will be referred to generally as “a track 250” unless a specific aspect of one of the tracks 250a, 250b, 250c is being discussed. Each track 250 defines a slot 310 along its length, and the track 250 is said to extend in the direction in which the slot 310 extends along the side of the panel 220 (i.e., into and out of the plane of FIG. 2). An element is said to be “parallel” or “perpendicular” to the track 250 if it extends in a direction that is parallel or perpendicular, respectively, to the direction in which the track 250 extends (i.e., the direction of the slot 310). An element is said to move along or parallel to the track 250 when the element moves within the track 250 in the direction in which the track 250 extends (i.e., the direction of the slot 310). The slot 310 has a slot width 320.

In this specification, a track 250 is said to open “inwardly” if the slot 310 opens toward the cargo space 230, is said to open “outwardly” if the slot 310 opens away from the cargo space 230 on the other side of the panel 220, and is said to open “upwardly” if the slot 310 opens upwardly away from the cargo floor 210. A side panel 220 may be configured with any arrangement and number of inwardly, outwardly, and upwardly opening tracks 250 in other embodiments by modifying the extrusion dies. Because the side panels 220 are extrusions, they can be made to substantially any length required for a given application.

Each track 250 includes the same elements (although only one of the tracks 250 is labeled with these elements to avoid clutter in the drawing): a base wall 330; a pair of sidewalls 340 extending perpendicular to the base wall 330 and parallel to each other; a pair of front walls 350 extending from the respective sidewalls 340 perpendicular to the sidewalls 340 and parallel to the base wall 330; and a pair of lips 360 extending from the front walls 350 toward the base wall 330 perpendicular to the base wall 330. These elements of the track 250 define a c-shaped channel 370. Each element includes an inner surface that faces into the c-shaped channel 370 and an outer surface that faces away from the c-shaped channel 370. The space between the sidewalls 340, front walls 350, and lips 360 defines an undercut portion 380 of the c-shaped channel 370. A gap 390 exists between the lips 360 and the base wall 330. The slot 310 of the track 250 is defined between the lips 360. The lips 360 are therefore a slot width 320 apart. The c-shaped channel 370 extends around three sides of the slot 310. The slot 310 can be said to be the mouth of the c-shaped channel 370. The outer surface 400 of the base wall 330 of inwardly-opening track 250a and the outer surface 410 of the front walls 350 of the outwardly-opening track 250b define portions of the outer vertical side or surface 420 of the panel 220 (facing outwardly away from the cargo space 230).

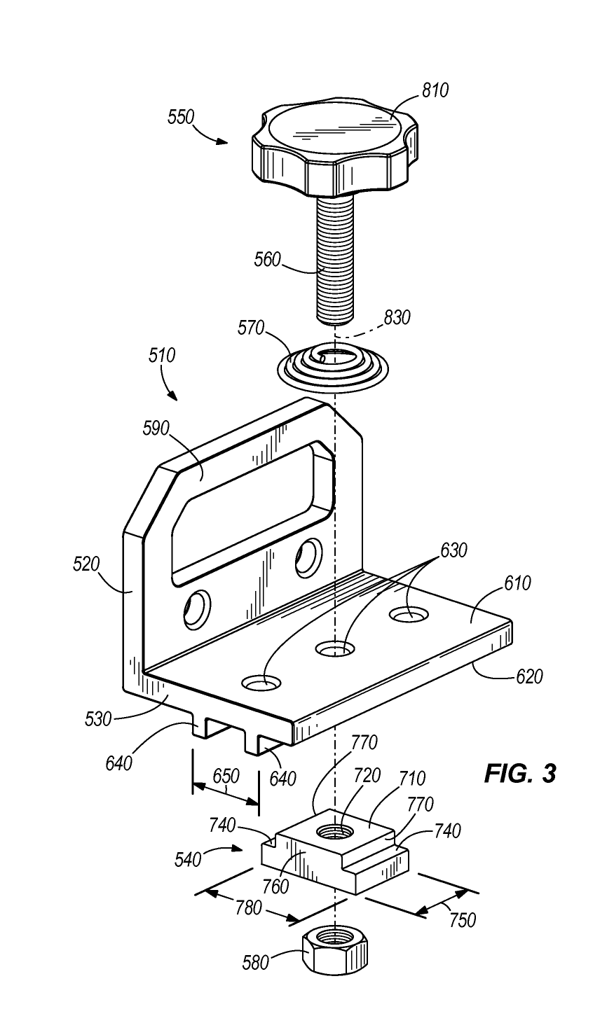

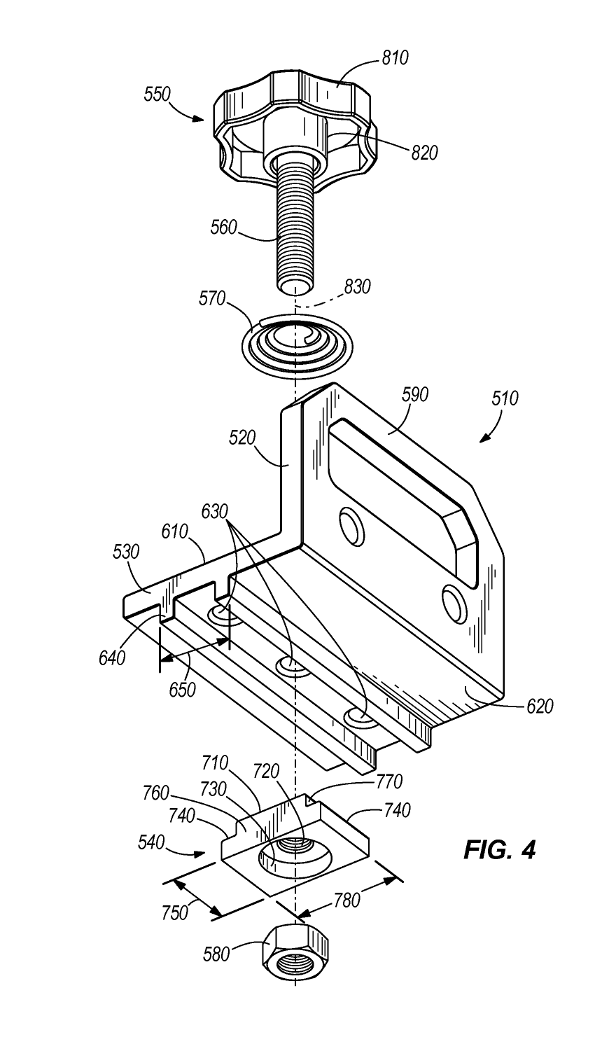

FIGS. 3 and 4 illustrate an attachment assembly 510 for use with the tracks 250 in the side panels 220. The attachment assembly 510 includes a work piece 520, a bracket 530, a t-nut 540, a knob 550, a threaded shaft 560, a linear spring 570, and a lock nut 580. The work piece 520 provides a handle 590 that a user or occupant can grasp or a cargo mounting member or anchor such as a hook, a cleat, or an eye to which cargo can be tied, secured or otherwise attached. In some embodiments, the work piece 520 can provide a shelf or supporting point for items (e.g., posts, sheets, boards) that are to be transported by the vehicle 110 in the cargo bed 160, but which need to be supported or need to have their movement restricted. The bracket 530 extends from the work piece 520 at a ninety-degree angle in the illustrated embodiment, and in the illustrated embodiment is integrally formed with the work piece 520. The bracket 530 includes a front surface 610, a rear surface 620, several through holes 630, and a pair of parallel guides 640 extending from the rear surface 620 on opposite sides of the through holes 630. The outer edges of the guides 640 are spaced from each other a distance 650 that is slightly smaller than the slot width 320.

The t-nut 540 includes a hub 710, a threaded hole 720 in the hub 710, a counter bore 730 in the hub 710, and a pair of shoulders 740 on opposite sides of the hub 710. The hub 710 and the shoulders 740 have equal widths 750. The t-nut 540 includes parallel continuous, flat side surfaces 760 that extend along the hub 710 and the shoulders 740. The width 750 of the t-nut 540 is defined between the side surfaces 760, and is slightly smaller than the slot width 320. The hub 710 is cube-shaped, and has shoulder flats 770 where the hub 710 meets the shoulders 740. The t-nut 540 has a major dimension 780 (which may also be referred to as the t-nut's length) extending from a distal end of one shoulder 740 to a distal end of the other 740, and as such, the t-nut 540 can be said to extend in the direction of the major dimension 780. The t-nut 540 is therefore said to be “parallel” to an element when the major dimension 780 is parallel to the direction in which the other element extends. The t-nut 540 is said to be “perpendicular” to an element when the major dimension 780 is perpendicular to the direction in which the other element extends.

The knob 550 includes a user graspable portion 810 and a mounting portion 820. The threaded shaft 560 is received in the mounting portion 820 and fixed for rotation with the knob 550. The threaded shaft 560 defines a main axis 830 of the attachment assembly 510. The threaded shaft 560 extends through the spring 570 and one of the through holes 630, with the spring 570 captured between the mounting portion 820 and the front surface 610 of the bracket 530. The threaded shaft 560 threads into the threaded hole 720 in the t-nut 540. The lock nut 580 threads onto the end of the threaded shaft 560. The counter bore 730 is of a larger diameter than the outer diameter of the lock nut 580, such that the lock nut 580 can be receive within the counter bore 730.

The spring 570 biases the knob 550 away from the front surface 610 of the bracket 530, parallel to the main axis 830 in a direction that moves the t-nut 540 toward the bracket 530, which may be referred to as a “clamping direction.” Because they are interconnected with the knob 550, the threaded shaft 560, t-nut 540, and lock nut 580 are also biased by the spring 570 parallel to the main axis 830 in the clamping direction. When not installed in a track 250, the spring 570 biases the t-nut 540 into abutment with the pair of guides 640. The direction opposite the clamping direction may be referred to as the “unclamping direction.”

FIGS. 5-9 illustrate the sequence of steps for mounting the attachment assembly 510 to a side panel 220. The first step, illustrated in FIG. 5, includes positioning the t-nut 540 parallel to the guides 640. The t-nut 540 and guides 640 are positioned parallel to the slot 310 in the track 250 and are inserted into the slot 310, with the rear surface 620 of the bracket 530 against the outer surface 410 of the front walls 350 of the track 250.

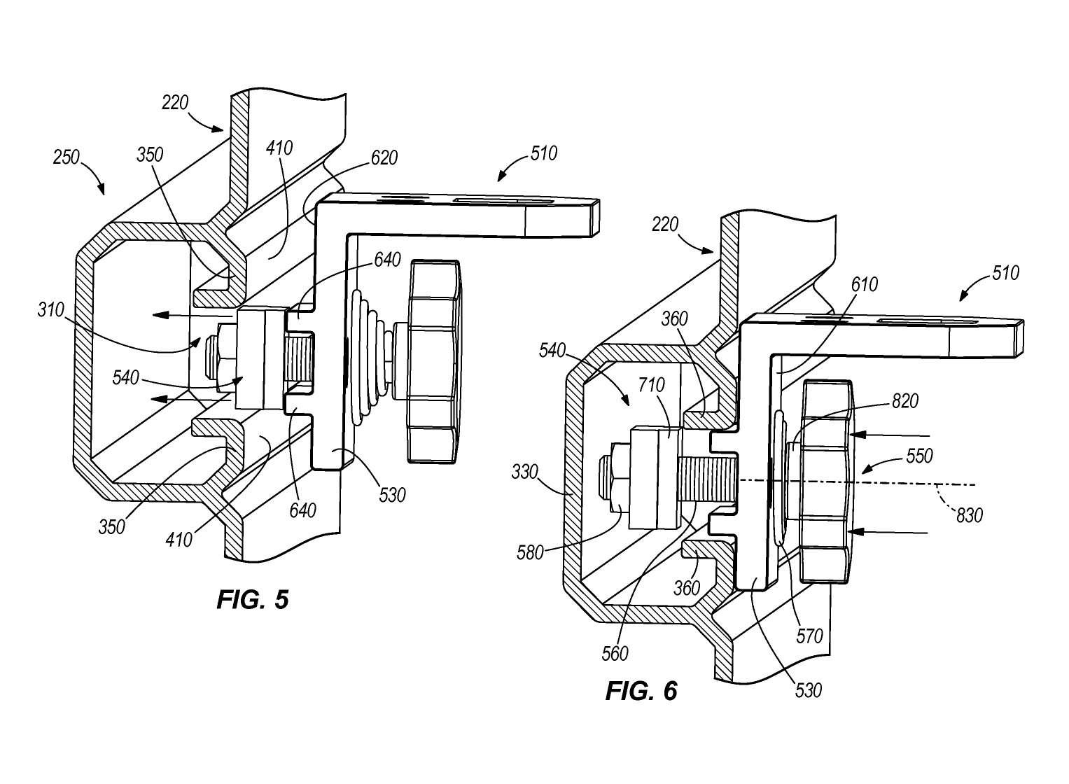

The second step, illustrated in FIG. 6, includes pushing the knob 550 in the direction of the main axis 830 toward the bracket 530, such that the threaded shaft 560, t-nut 540, and lock nut 580 move toward the base wall 330. The direction in which the knob 550 is pushed to move the t-nut 540 away from the bracket 530 may be referred to as the “unclamping direction.” As the knob 550 is pushed toward the bracket 530, the spring 570 deflects between the mounting portion 820 and the front surface 610 of the bracket 530. The hub 710 of the t-nut 540 clears the ends of the lips 360. In the illustrated embodiment, the threaded shaft 560 is not long enough to bottom out against the base wall 330 when the knob 550 has bottomed out against the bracket 530. The knob 550 bottoms out against the bracket 530 when the spring 570 is completely deflected between the mounting portion 820 and the bracket 530. In the illustrated embodiment, the coils of the spring 570 are arranged in a spiral pattern of tightening circles, such that the spring 570 defines a flat spiral when the spring 570 is completely deflected.

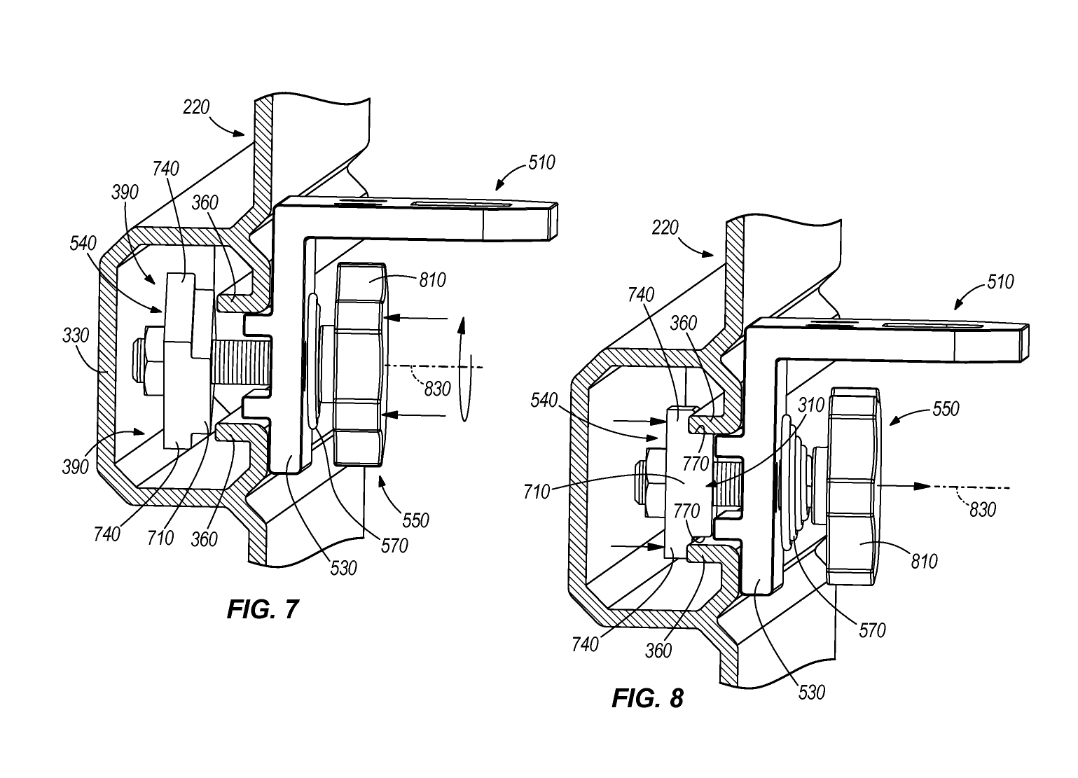

In the third step, illustrated in FIG. 7, the knob 550 is turned, by grasping and turning the user graspable portion 810, about the main axis 830 with the knob 550 bottomed out to keep the hub 710 of the t-nut 540 clear of the ends of the lips 360. In the illustrated embodiment, the knob 550 can be turned in either a clockwise or counterclockwise direction to pivot the shoulders 740 of the t-nut 540 into the gap 390 between the lips 360 and the base wall 330. As soon as a portion of the hub 710 of the t-nut 540 is in the gap 390, the knob 550 does not need to be pushed, and the spring 570 can be permitted to bias the knob 550 away from the bracket 530, with the hub 710 of the t-nut 540 bearing against the ends of the lips 360. The knob 550 is turned in this step until the shoulders 740 register with the lips 360, which occurs when the t-nut 540 is perpendicular to the lips 360. In the fourth step, illustrated in FIG. 8, the moment that the shoulders 740 register with the lips 360, the spring 570 pushes the knob 550 in the clamping direction further away from the bracket 530. The hub 710 of the t-nut 540 slides into the slot 310 between the lips 360 with the lips 360 adjacent the shoulder flats 770 of the hub 710, and the shoulders 740 are drawn against the ends of the lips 360 with an audible snap.

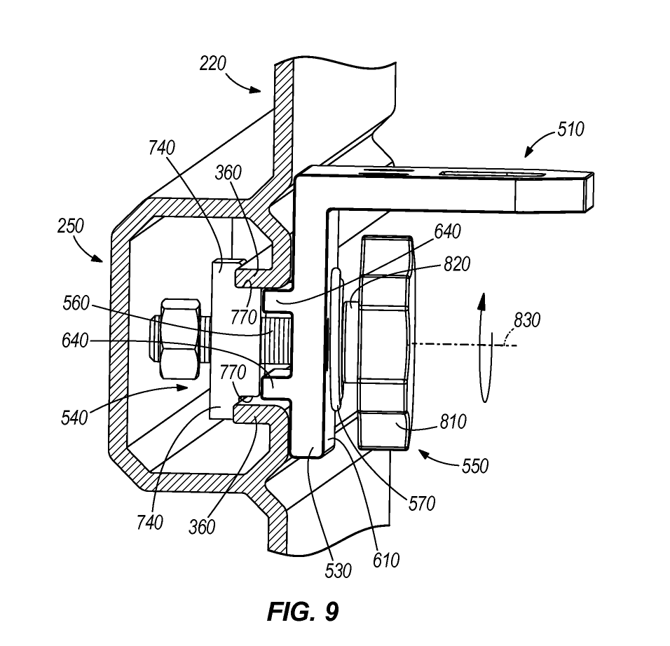

In the fifth step, illustrated in FIG. 9, the knob 550 is rotated clockwise, by grasping and turning the user graspable portion 810, to advance the threaded shaft 560 in the threaded hole 720 in the t-nut 540. The lips 360 engage the shoulder flats 770 while the threaded shaft 560 is rotated into the threaded hole 720. This advances the knob 550 closer and closer to the bracket 530 with each turn of the knob 550. The attachment assembly 510 retained in the desired location in the track 250 while the knob is rotated 550, by the clamping force arising from the spring 570 biasing the t-nut 540 against the lips 360. The spring 570 is deflected between the mounting portion 820 of the knob 550 and the front surface 610 of the bracket 530 until the mounting portion 820 bottoms out against the bracket 530. Once the knob 550 has bottomed out against the bracket 530, the lips 360 of the track 250 are clamped between the mounting portion 820 of the knob 550 and the shoulders 740 of the t-nut 540. The lips 360 and guides 640 of the bracket 530 can be sized such that the guides 640 abut the t-nut 540 when a desired clamping force has been achieved, or may be sized such that the guides 640 never abut the t-nut 540.

It is possible to temporarily and releasably couple the attachment assembly 510 to the side panel 220 by properly tightening the knob 550. When the knob 550 is bottomed out against the bracket 530, the clamping force will be very strong and the attachment assembly 510 will be substantially fixed and immovable with respect to the track 250. Because of the user graspable portion 810 of the knob 550, and the t-nut 540 being secured between the lips 360, the attachment assembly 510 can be manually tightened and loosened with respect to the panels 220 without the use of tools. In addition, to the clamping force, the lips 360 engage the guides 640 to resist pivoting of the attachment assembly 510 about the main axis 830.

The attachment assembly 510 can be slid to any desired point along the track 250 during the first step described above while the t-nut 540 is parallel to the slot 310, or during the second and third steps while the knob 550 is pushed in the unclamping direction and the t-nut 540 is non-parallel with the slot 310, because there is no clamping force between the t-nut 540 and the track 250 under such conditions. The attachment assembly 510 can also be slid along the track while the spring 570 applies the clamping load, if sufficient sliding force is applied to the attachment assembly 510 to overcome frictional forces arising from the normal clamping force of the spring 570. The guides 640 prevent rotation of the attachment assembly 510 about the main axis 810 while the attachment assembly 510 is slid along the track 250.

The attachment assembly 510 is moved with respect to the side panel 220 or removed from the side panel 220 by following the steps outlined above in reverse order. More specifically, the knob 550 is rotated counterclockwise until the lock nut 580 is within the counter bore 730 in the t-nut 540 and bears against the t-nut 540. Further rotation of the knob 550 in the counterclockwise direction is resisted by the lock nut 580 bearing against the t-nut 540 while the lips 360 engage the shoulder flats 770. The operator then pushes the knob 550 toward the bracket 530, the spring 570 is deflected, and the hub 710 of the t-nut 540 clears the ends of the lips 360. With the spring 570 deflected and the hub 710 of the t-nut 540 clear of the ends of the lips 360, the knob 550 can be rotated clockwise or counterclockwise. The t-nut 540 rotates with the knob 550 and threaded shaft 560 even when the knob 550 and threaded shaft 560 are rotated counterclockwise, because of the frictional engagement between the lock nut 580 and the t-nut 540. The knob 550 is rotated until the t-nut 540 is parallel to the slot 310, at which time the knob 550 can be released and the attachment assembly 510 can be removed from the track 250 (with the t-nut 540 being removed through the slot 310) or moved to a new position in the track 250.

The side panels 220 can be included with an OEM utility vehicle, or can be substituted for existing panels by removing the existing panels of the vehicle and retrofitting the vehicle with the side panels 220. If desired by the operator of the vehicle, elongated track covers can be snapped into the slots 310 to give the panel surface 420 a smoother, uninterrupted appearance that is substantially flush. Such track covers can be extruded resilient (e.g., plastic) parts, for example, that snap into the slots 310 and extend the entire length of the panel 220, or extend between attachments 510.

The attachment assembly 510 can therefore be said to include a first piece (e.g., the t-nut), a second piece (e.g, the bracket 530), and a clamping mechanism (e.g, the knob 550 and threaded shaft 560 assembly) interconnecting the first piece and second piece. The first piece is sized and shaped to be inserted into the c-shaped channel 370 through the slot 310, and once within the channel 370, turned such that the first piece bears against the lips 360 from within the channel. The second piece is sized and shaped to extend across the slot 310 and bear against the track 250 outside of the channel 370. The clamping mechanism is actuable in a first direction (e.g, rotating the knob clockwise) to draw the first piece toward the second piece to clamp a portion of the track 250 between the first and second pieces and secure the attachment assembly 510 with respect to the side panel 220. The clamping mechanism is actuable in a second direction (e.g, rotating the knob counterclockwise) to move the first piece away from the second piece to release a clamping force between the first and second piece on the track 250, such that the attachment assembly 510 may be slid along the track 250 to a desired location.

Thus, the invention provides, among other things, a panel and attachment system for a utility vehicle. Various features and advantages of the invention are set forth in the following claims.

What is claimed is:

1. A cargo bed for a utility vehicle, the cargo bed comprising:
a floor arranged generally horizontally on the vehicle;
a plurality of side panels mounted to the floor and extending vertically, the floor and the side panels defining between them a cargo holding space;
a track formed integrally with at least one of the side panels; and
an attachment adapted to be inserted into the track, moved along the track into a desired position, and clamped with respect to the track to resist movement of the attachment with respect to the side panel.

2. The cargo bed of claim 1, wherein the track defines a channel and includes lips that define a slot for access to the channel;
wherein the attachment includes a first piece, a second piece, and a clamping mechanism interconnecting the first piece and second piece;
wherein the first piece is sized and shaped to be inserted into the channel through the slot, and once within the channel, turned such that the first piece bears against the lips from within the channel;
wherein the second piece is sized and shaped to extend across the slot and bear against the track outside of the channel;
wherein the clamping mechanism is actuable in a first direction to draw the first piece toward the second piece to clamp a portion of the track between the first and second pieces and rigidly affix the attachment with respect to the side panel; and
wherein the clamping mechanism is actuable in a second direction to move the first piece away from the second piece to release a clamping force between the first and second piece on the track, such that the attachment may be slid along the track to a desired location.

3. The cargo bed of claim 2, wherein the attachment further includes a linear spring biasing the first and second pieces toward each other; and wherein the first piece is inserted into the channel through the slot by applying a manual force to overcome the bias of the linear spring to separate the first piece from the second piece a sufficient distance to position the first piece within the channel.

4. The cargo bed of claim 1, wherein the attachment includes a first piece, a second piece, and a clamping mechanism interconnecting the first piece and second piece; wherein the clamping mechanism is actuable in a first direction to draw the first portion toward the second portion to clamp a portion of the integrally-formed track between the first portion and second portion.

5. The cargo bed of claim 1, wherein each side panel defines oppositely-facing first and second vertical surfaces, the first vertical surface of each side panel facing into the cargo space and the second vertical surface of each side panel facing away from the cargo space; wherein the integrally-formed track is formed in one of the first vertical surface and second vertical surface.

6. The cargo bed of claim 1, wherein the integrally-formed track includes a base wall, first and second sidewalls extending from the base wall, a first front wall extending from the first sidewall, a second front wall extending from the second sidewall, a first lip extending from the first front wall, a second lip extending from the second front wall, and a slot between the first and second lips; wherein a portion of the clamping mechanism extends through the slot; wherein actuation of the clamping mechanism causes the first portion of the attachment to bear against one side of the first and second lips and causes the second portion of the attachment to bear against an opposite side of the first and second lips.

7. The cargo bed of claim 1, further comprising resilient strips adapted for insertion into the track to create a flush surface on the side panel.

8. The cargo bed of claim 1, wherein the attachment is releasable by actuating the clamping mechanism in a second direction opposite the first direction; wherein the attachment is slidable within the track to a new position; and wherein the attachment is secured in the new position by actuating the clamping mechanism in the first direction.

9. The cargo bed of claim 1, wherein at least one of the side panels is extruded to form alternating tracks opening inwardly and outwardly with respect to the cargo space, such that attachments can be mounted on opposite sides of the side panels for attachment of objects within and without the cargo space.

10. An attachment for use in a cargo bed having a track that includes lips and a slot between the lips, the slot having a slot width, the attachment comprising:
a first piece;
a second piece; and
a clamping mechanism interconnecting the first piece and second piece;
wherein the first piece is sized and shaped to be inserted into the slot, and once within the track, turned such that the first piece bears against the lips from within the track;
wherein the second piece is sized and shaped to extend across the slot and bear against the track outside of the track;
wherein the clamping mechanism is actuable in a first direction to draw the first piece toward the second piece to clamp a portion of the track between the first and second pieces and rigidly fix the attachment with respect to the track; and
wherein the clamping mechanism is actuable in a second direction to move the first piece away from the second piece to release a clamping force between the first and second piece on the track, such that the attachment may be slid along the track to a desired location.

11. The attachment of claim 10, wherein the clamping mechanism includes a user graspable knob and a threaded shaft affixed to the knob for rotation with the knob; wherein the threaded shaft extends through a hole in the first piece and threads into the second piece; wherein the clamping mechanism is actuable in the first direction without the use of tools by rotating the knob and threaded shaft to draw the first piece toward the second piece; and wherein the clamping mechanism is actuable in the second direction without the use of tools by rotating the knob and threaded shaft to move the first piece away from the second piece.

12. The attachment of claim 11, wherein the first piece comprises a t-nut having a hub and shoulders on opposite sides of the hub; wherein the t-nut has a width slightly less than the slot width and a length larger than the slot width; wherein the shoulders engage the lips from within the track with the hub being received within the slot.

13. The attachment of claim 10, wherein the clamping mechanism is interconnected with the first piece and extends through the second piece; the attachment further comprising a linear spring between the second piece and a portion of the clamping mechanism; wherein the linear spring biases the clamping mechanism in a clamping direction to move the first piece toward the second piece.

14. The attachment of claim 13, wherein the first piece includes a width that is slightly smaller than the slot width and a length that is larger than the slot width; wherein the clamping mechanism is manually actuated to deflect the linear spring and move the first piece away from the second piece in an unclamping direction with the first piece parallel to the slot, such that the first piece passes through the slot and into the track; and wherein the clamping mechanism is rotatable to rotate the first piece within the track to position the first piece perpendicular to the slot such that the first piece extends across the slot.

15. A method for configuring a cargo bed of a utility vehicle, the method comprising:
extruding a plurality of side panels for the cargo bed, wherein at least one of the side panels includes an integrally-formed track that is formed within the side panel while extruding the side panel, the track including a pair of lips that at least partially define a c-shaped channel, a slot having a slot width being defined between the lips;
providing a cargo bed floor arranged generally horizontally on the vehicle;
mounting the plurality of side panels to the floor with the side panels extending vertically;
providing an attachment that includes a first piece, a second piece, and a clamping mechanism interconnecting the first piece and second piece;
inserting the first piece into the c-shaped channel through the slot;
twisting the first piece within the c-shaped channel such that the first piece extends across the slot against the lips within the c-shaped channel;
moved the attachment along the track into a desired position; and
actuating the clamping mechanism to draw the first piece toward the second piece to clamp the lips of the track between the first and second pieces to resist movement of the attachment with respect to the side panel.

16. The method of claim 15, wherein the step of extruding a plurality of panels includes integrally-forming in the panel at least one track that opens inward to a cargo space within the cargo bed, at least one track that opens outward away from the cargo space, and at least one track that opens upward away from the cargo bed floor.

17. The attachment of claim 15, wherein providing an attachment includes providing a user graspable knob and a threaded shaft affixed to the knob for rotation with the knob, extending the threaded shaft through a hole in the first piece and threading the threaded shaft into the second piece; wherein actuating the clamping mechanism in the first direction includes grasping the user graspable knob and rotating the knob without the use of tools to draw the first piece toward the second piece.

18. The attachment of claim 15, wherein providing the attachment includes providing a t-nut as the first piece, the t-nut having a hub and shoulders on opposite sides of the hub; wherein inserting the first piece in the c-shaped channel through the slot includes aligning the t-nut parallel to the slot; wherein twisting the first piece includes rotating the t-nut within the c-shaped channel to be perpendicular to the slot; and wherein actuating the clamping mechanism includes engaging the lips from within the c-shaped channel with shoulders.

19. The attachment of claim 15, wherein providing an attachment includes providing a linear spring between the second piece and a portion of the clamping mechanism; wherein the linear spring biases the clamping mechanism in a clamping direction to move the first piece toward the second piece.

20. The attachment of claim 19, wherein providing an actuator includes making the width of the first piece slightly smaller than the slot width and making a length of the first piece larger than the slot width; wherein inserting the first piece into the c-shaped channel through the slot includes pushing on the clamping mechanism to deflect the linear spring and move the first piece away from the second piece in an unclamping direction with the first piece parallel to the slot; and wherein actuating the clamping mechanism includes manually rotating the clamping mechanism without the use of tools to rotate the first piece within the c-shaped channel to position the first piece perpendicular to the slot such that the first piece extends across the slot.
